(19) United States
(12) Patent Application Publication
(10) Pub. No.: US 2006/0163820 A1
(43) Pub. Date: Jul. 27, 2006

(54) Metal gasket

(75) Inventors: Tsunekazu Udagawa, Ichikawa-shi (JP); Yoshio Yamada, Utsunomiya-shi (JP); Yoshio Miyaoh, Tokyo (JP)

Correspondence Address: KANESAKA BERNER AND PARTNERS LLP, SUITE 300, 1700 DIAGONAL RD, ALEXANDRIA, VA, 22314-2848, US

(73) Assignee: ISHIKAWA GASKET CO., LTD, Tokyo (JP)

(21) Appl. No.: 11/339,655

(22) Filed: Jan. 26, 2006

(30) Foreign Application Priority Data
Jan. 26, 2005 (JP) 2005-017957

(51) Int. Cl. F02F 11/00

(52) U.S. Cl. 277/593

(57) ABSTRACT

A metal gasket for providing a seal between a cylinder head and a cylinder block of an engine is a laminate of a first metal plate, a second metal plate, and a third metal plate. The first metal plate has a folded portion for positioning around a cylinder bore, the second metal plate has a first full bead inside the folded portion to provide a primary sealing portion, and the third metal plate has a second full bead provided around an outer circumference of the first full bead to provide a secondary sealing portion. The primary sealing portion has a primary sealing surface pressure, and the secondary sealing portion has a secondary sealing surface pressure less than the primary sealing surface pressure. The secondary sealing portion provides enhanced following capability during engine operation.

### BACKGROUND OF THE INVENTION AND RELATED ART STATEMENT

The present invention relates to a metal gasket to be installed between two engine members, such as a cylinder head and the cylinder block of an engine, so as to seal therebetween.

When a joint surface of the cylinder head and cylinder block (cylinder body) of an auto engine (internal combustion) is sealed, a metal cylinder head gasket is installed therebetween and seals combustion gas, coolant water, or lubricating oil.

When the periphery of a cylinder bore (combustion chamber bore) is sealed, high-temperature combustion gas is required to be sealed in such that a folded portion (grommet portion) is provided by folding back the marginal part of the bore, and also multiple beads are provided. Accordingly, the periphery of the cylinder bore is sealed by multiple sealing lines.

One of the cylinder head gaskets proposed is a cylinder head gasket comprising: the folded portion provided in the first plate; the first full bead provided in the first plate inside the folded portion; a half bead provided in the first plate outside the folded portion; and a second full bead provided in a second plate outside the half bead (for example, refer to Japanese Patent Publication No. 2001-173786).

Because engine materials are aluminum-alloyed or reduced in weight due to a reduction in the weight of engines, the rigidity of the engine members such as the cylinder block and cylinder head tends to decline. Accordingly, these members are easily transformed in engine operation.

Therefore, in the case of using a bead whose sealing surface pressure is locally high, or a bead whose capability for following the movement in a vertical direction of the cylinder head (following capability) during the engine operation is poor, the top of the bead of the gasket is contacted with the cylinder head (or cylinder block) due to the movement of the cylinder head so that Brinelling (depression) occurs in the cylinder head (or cylinder block). As a result, the sealing surface pressure around the cylinder bore becomes uneven, and the sealing performance declines.

On the one hand, it is known that when a spring steel is used for a sealing bead around the cylinder bore, the bead's capability for following the vertical movement of the cylinder head during the engine operation improves. However, when the spring steel is used for a part of the bead of a primary sealing which requires high surface pressure, the bead displays cracks due to repeated vertical movements of the cylinder head during the engine operation.

The present invention is made in order to solve the above-mentioned problems. An object of the invention is to provide a metal gasket that has improved sealing performance relative to the cylinder bore, and that is able to prevent the bead from cracking even under the repeated vertical movements of the cylinder head during the engine operation.

Further objects and advantages of the invention will be apparent from the following description of the invention.

### SUMMARY OF THE INVENTION

In order to achieve the above-described objects, a metal gasket of the present invention which seals between a cylinder head and a cylinder block of an engine includes: a folded portion of a first metal plate provided around a cylinder bore; a first full bead of a second metal plate provided inside the folded portion; and a second full bead formed in a third metal plate laminated in the first metal plate around the outer circumference of the first full bead.

The second metal plate is made with an annealing steel, and formed thinner than the first metal plate, and the third metal plate is made with a spring steel.

Also, the sealing surface pressure generated in a secondary sealing portion of the second full bead is made smaller than the sealing surface pressure generated in a primary sealing portion of the first full bead. The surface pressure of the primary sealing portion is strengthened and the following capability of the secondary sealing portion is strengthened.

In addition, the above-mentioned sealing surface pressures are compared by using an average value of the largest surface pressure of each cross-section surface in a circumferential direction, respectively.

Alternatively, the metal gasket sealing between the cylinder head and the cylinder block of the engine includes: the folded portion of the first metal plate provided around the cylinder bore; the first full bead of the second metal plate provided inside the folded portion; and the second full bead formed in the third metal plate laminated in the first metal plate around the outer circumference of the first full bead.

The height of the bead of the second full bead is made higher than the height of the bead of the first full bead, and the spring steel is used for the second metal plate and the third metal plate. At the same time, the second metal plate is made thinner than the third metal plate, and the hardness of the third metal plate is formed higher than that of the second metal plate.

The sealing surface pressure generated in the secondary sealing portion of the second full bead is made smaller than the sealing surface pressure generated in the primary sealing portion of the first full bead. Accordingly, the surface pressure of the primary sealing portion is strengthened and the following capability of the secondary sealing portion is strengthened.

Specifically, in a structure with a combustion-chamber folding type of the metal laminate gasket, the first full bead is provided with the annealing steel in the primary sealing portion inside the folded portion, and the second full bead is provided with the spring steel in the abutting secondary sealing portion.

Alternatively, the spring steel is used for the first full bead and the second full bead, and the hardness of the spring steel of the second full bead is formed higher than that of the spring steel of the first full bead.

Also, in the above-mentioned metal gasket, multiple third metal plates are provided, and multiple second full beads are overlapped and laminated. Due to the structure, the following capability and compressibility of the second full beads can be significantly improved.

According to the structure, the spring steel is used for the second full beads or first and second full beads and at the same time, the sealing surface pressures of the second full beads are made smaller than the sealing surface pressure of the first full bead.

As a result, the bead's capability for following the vertical movement of the cylinder head during the engine operation can be improved. Herewith, the sealing function can be shared between the primary sealing portion and secondary sealing portions in such a way that the primary sealing portion of the first full bead has the strong surface pressure and the secondary sealing portions of the second full beads have the strong following capabilities. Accordingly, the primary sealing portion and the secondary sealing portions can be effectively sealed without cracking the bead.

Specifically, in the metal gasket with the folding type of combustion-chamber hole, the sealing beads made of a spring material are provided in the secondary sealing portions whose surface pressures are relatively low, and not provided in a high surface pressured part of the primary sealing. As a result, the following capability of the bead can be ensured and the bead can be protected from a crack. At the same time, the sealing function is effectively shared between the primary sealing portion with the strong surface pressure, and the secondary sealing portions with the strong following capabilities so that high sealing performance can be maintained.

According to the metal gasket of the present invention, in the gasket with the folding type of combustion-chamber hole, the sealing surface pressures generated in the second full beads are made smaller than the sealing surface pressure generated in the first full bead, and the sealing function is shared between the primary sealing portion with the strong surface pressure and the secondary sealing portions with the strong following capabilities.

As a result, the surface pressure of the primary sealing portion can be made lower than the surface pressure of the conventional primary sealing portion, and the first full bead can be protected from cracking.

Also, the secondary sealing portions which have lower surface pressure than the conventional primary sealing portion and higher surface pressure than the conventional secondary sealing portion are made of the second full beads using the spring steel. As a result, the second full beads can be protected from cracking, and at the same time, the following capability can be ensured. Therefore, high sealing performance can be ensured even in the second full bead.

Moreover, since the top of the bead does not directly come into contact with engine members, it is difficult to generate Brinelling.

Therefore, high sealing performance for the cylinder bore can be achieved and also, enough capability for following the repeated vertical movements of the cylinder head during engine operation can be achieved. Accordingly, cracking of the bead can be prevented.

### BRIEF DESCRIPTION OF THE DRAWINGS

FIG. 1 is a partial sectional view showing a metal gasket according to a first embodiment of the present invention;

FIG. 2 is a partial sectional view showing a metal gasket according to a second embodiment of the present invention;

FIG. 3 is a partial sectional view showing a metal gasket according to a third embodiment of the present invention; and

FIG. 4 is a view showing a typical pressure distribution of a metal gasket according to the first embodiment of the present invention.

### DETAILED DESCRIPTION OF PREFERRED EMBODIMENTS

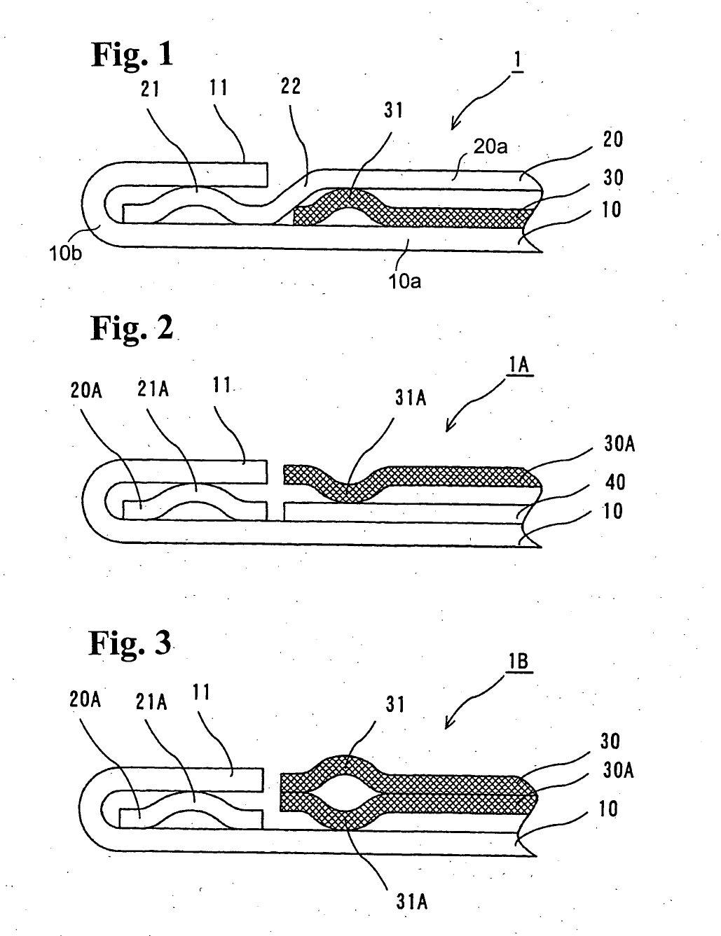

Hereinafter, embodiments of a metal gasket according to the present invention will be explained with reference to the drawings. In addition, FIGS. 1-3 are explanatory-type drawings, and structures are exaggeratedly shown by different sizes of cylinder bores, full beads, thicknesses of a metal plate, and so on from actual sizes, so that the structures are even more easily understood.

A metal gasket according to the present invention is a cylinder head gasket to be installed between engine members such as a cylinder head and the cylinder block (cylinder body) of an engine. The metal gasket seals in high-temperature and high-pressure combustion gas of cylinder bores, and fluids such as coolant water or oil and so on in coolant-water channels or coolant-oil channels, and so on.

The metal gasket is manufactured in accordance with the shape of the engine member such as the cylinder block. The metal gasket includes the cylinder bore (combustion-chamber hole), a liquid hole for circulating coolant water or engine oil, and a head bolt hole for tightening the head bolt.

As shown in FIG. 1, a metal gasket 1 according to a first embodiment is constituted by a first metal plate 10, second metal plate 20, and third metal plate 30. The first metal plate 10 is made of a mild steel plate, the second metal plate 20 is made of an annealing steel such as a stainless annealing material (annealing material), and the third metal plate 30 is made of a spring steel such as a stainless well-tempered material (spring steel plate), respectively.

A folded portion (grommet) 11 of the first metal plate 10 is provided around a cylinder bore which is a sealing-target hole. Also, the second metal plate 20 is provided with a first full bead 21 which becomes a projection or depression (projection in FIG. 1) to the folded portion 11 side, and is disposed inside the folded portion 11. A half bead 22 is provided around the first full bead 21, and a second full bead 31 provided in the third metal plate 30 is abutting against the half bead 22.

The first metal plate 10 also includes a base portion 10a with a curved portion 10b extending from the base portion 10a to define a cylinder bore. The folded portion 11 extends from the curved portion 10b. The second metal plate 20 also includes a base portion 20a extending outwardly from the half bead 22. The third metal plate 30 is disposed above the base portion 10a, and the base portion 20a is disposed above the third metal plate 30.

The metal gasket 1 is constituted by laminating first, second, and third metal plates 10, 20, 30. In addition, in FIG. 1, the second full bead 31 is provided in such a way so that it projects to the folded portion 11 side; however, the second full bead 31 may be provided in such a way so that it depresses to the folded portion 11 side.

In this structure, the sealing surface pressure generated in the second full bead 31 is smaller than the sealing surface pressure generated in the first full bead 21. Accordingly, the surface pressure of a primary sealing portion is strengthened, and the following capability is strengthened at a secondary sealing portion.

An average value which averaged the largest surface pressure of each cross-sectional surface regarding each circumferential direction in a circumferential direction is used for comparing the sealing surface pressures. Accordingly, based on calculation, experiment and so on, the width, height and shape of the bead of the first full bead 21 and second full bead 31 is selected.

Incidentally, the shape of the cross-sectional surface of the full beads 21, 31 is not specifically limited, and shapes of well-known beads such as an arc, wave pattern, triangle, trapezoid, quadrangle, and so on can be used.

Also, in the first embodiment, the following capability of the secondary sealing portion is strengthened by using the spring steel with a large spring performance for the second full bead 31.

At the same time, by forming the second full bead 31 with an insert bead, the second full bead 31 does not directly contact the contact surface of an engine member side by the second metal plate 20, which becomes an upper wall.

Due to the structure, the Brinelling generated by the pressure bonding of the top of the second full bead 31 and the contact surface of the engine member such as an aluminum cylinder head can be prevented. As a result, a depression can be prevented from being generated in the engine member side, and the sealing performance can be prevented from deteriorating.

Also, as shown in FIG. 2, a metal gasket 1A according to a second embodiment is constituted by: first metal plate 10; second metal plate 20A in the form of a ring; third metal plate 30A; and fourth metal plate 40. The first metal plate 10 and fourth metal plate 40 are made of the mild steel plate; the second metal plate 20A is made of the annealing steel; and the third metal plate 30A is made of the spring steel, respectively.

The folded portion 11 of the first metal plate 10 is provided around the cylinder bore which is the sealing-target hole. Also, the first full bead 21A which becomes the projection or depression (projection in FIG. 2) to the folded portion 11 side is provided on the annular second metal plate 20A, and is disposed inside the folded portion 11. The fourth metal plate 40 is provided around the first full bead 21A. In addition, the second full bead 31A is provided in the third metal plate 30A in such a way so that it is depressed to the folded portion 11 side. The metal gasket 1A is constituted by laminating the first-fourth metal plates 10, 20A, 30A, 40.

Even in this structure, as in the case of the first embodiment, the sealing surface pressure generated in the second full bead 31A is made smaller than the sealing surface pressure generated in the first full bead 21A.

In the second embodiment, the following capability of the secondary sealing portion is strengthened by using the spring steel with the large spring performance for the second full bead 31A.

At the same time, the second full bead 31A is formed by the bead so that it has a dent to the folded portion 11 side so that the top of the projection of the second full bead 31A does not directly contact the mounted surface of an engine. Due to the structure, the Brinelling (depression) can be prevented from being generated in the contact surface of the aluminum engine member.

Also, as shown in FIG. 3, a metal gasket 1B according to a third embodiment is constituted by: first metal plate 10; second metal plate 20A; and two third metal plates 30, 30A. The first metal plate 10 is made of the mild steel plate; the second metal plate 20A is made of the annealing steel; and the third metal plates 30, 30A are made of a spring material, respectively.

The folded portion 11 of the first metal plate 10 is provided around the cylinder bore which is the sealing-target hole. Also, the first full bead 21A which becomes the projection or depression (projection in FIG. 3) to the folded portion 11 side is provided on the second metal plate 20A, and is disposed inside the folded portion 11. The second full beads 31, 31A whose depressed portions are facing each other are provided in the two third metal plates 30, 30A around the first full bead 21A and outside the folded portion 11. The metal gasket 1B is constituted by laminating the first-third metal plates 10, 20A, 30 and 30A.

Even in this structure, as well as the first and second embodiments, the sealing surface pressure generated in the second full beads 31, 31A is made smaller than the sealing surface pressure generated in the first full bead 21A.

In the third embodiment, the secondary sealing portion is strengthened by using the spring steel with the large spring performance for the second full beads 31, 31A. In this case, the top of the second full bead 31 directly contacts the contact surface of the engine member. However, the secondary sealing beads 31, 31A are double-provided above and below, so that the following capability and compressibility become additionally larger, and the compressibility of the bead portion is made larger than that of the single bead portion. Accordingly, an attack on the contact surface of the engine member can be absorbed.

In the above-mentioned first-third embodiments, the reason why the sharing or supporting rate of the sealing surface pressure at the second full bead 31 can be made larger than that of a conventional metal gasket is the following. The following capability and compressibility are strengthened by using the spring steel for the second full beads 31, 31A, and even in the large sealing surface pressure, the generation of the Brinelling in the contact surface of the engine member can be prevented.

In the first-third embodiments, the second metal plate 20 is made of annealing steel, and the third metal plates 30, 30A are made of spring steel, respectively.

However, in fourth-sixth embodiments of the invention, the second metal plate 20 and third metal plates 30, 30A are made of the spring steel instead. At the same time, the second metal plate 20 is made thinner than the third metal plates 30, 30A, and the degree of hardness of the third metal plates 30, 30A is made higher than that of the second metal plate 20.

Also, in the fourth and fifth embodiments (same structure as shown in FIGS. 1 and 2, but the materials used are different as stated above), the height of the beads of the second full beads 31, 31A is made higher than that of the beads of the first full beads 21, 21A. In the sixth embodiment (same structure as shown in FIG. 3, but the materials used are different as stated above), the sum of the heights of the beads of the second full bead 31 and second full bead 31A are made higher than the heights of the beads of the first full beads 21, 21A.

Due to the structure, the following capability and compressibility in the first full bead 21 can be strengthened, and at the same time, the surface pressure in the second sealing beads 31, 31A can be easily increased. As a result, even in the structure, the sealing surface pressure generated in the second full beads 31, 31A can be made smaller than the sealing surface pressure generated in the first full bead 21. Additionally, the surface pressure of the primary sealing portion can be strengthened so that the following capability can be easily strengthened at the secondary sealing portion. Also, the same effect as the first-third embodiments can be obtained.

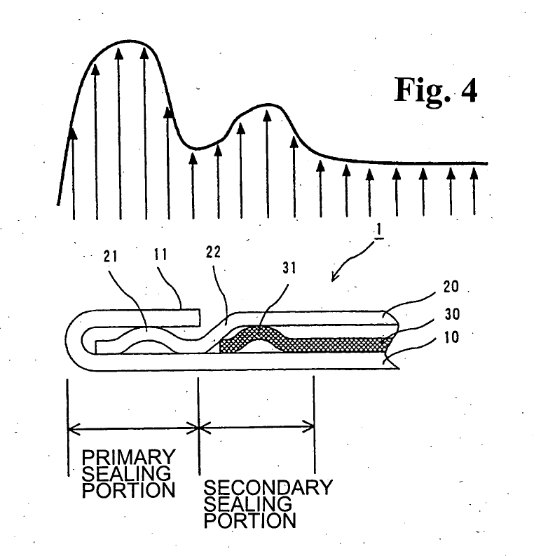

FIG. 4 shows a pressure distribution of the metal gasket according to the first embodiment as a typical pressure distribution of the metal gasket in the first-sixth embodiments.

While the invention has been described with reference to specific embodiments thereof, the description is illustrative, and the scope of the present invention is limited only by the appended claims.

The disclosure of Japanese Patent Application No. 2005-017957 filed on Jan. 26, 2005, is incorporated herein.

What is claimed is:

1. A metal gasket for providing a seal between a cylinder head and a cylinder block of an engine, comprising:
a first metal plate with a folded portion for surrounding a cylinder bore;
a second metal plate with a first full bead provided inside the folded portion, the first full bead providing a primary sealing portion; and
a third metal plate situated above the first metal plate and having a second full bead disposed around the first full bead, said second full bead providing a secondary sealing portion forming a sealing pressure less than that of the primary sealing portion and having a characteristic following movement of the engine.

2. A metal gasket according to claim 1, wherein said second metal plate consists of an annealing steel and has a thickness less than that of the first metal plate, and the third metal plate consists of a spring steel.

3. A metal gasket according to claim 2, wherein said second metal plate has a base portion disposed on the third metal plate, and a half bead situated between the first full bead and the base portion.

4. A metal gasket according to claim 3, wherein said second full bead is located outside the folded portion and the half bead.

5. A metal gasket according to claim 1, wherein said second metal plate has a ring shape, and the third metal plate is situated so that the second full bead projects toward a base portion of the first metal plate.

6. A metal gasket according to claim 1, wherein said second full bead has a height greater than that of the first full bead, and the second and third metal plates consist of a spring plate.

7. A metal gasket according to claim 6, wherein said second metal plate has a thickness less than that of the third metal plate, and a hardness less than that of the third metal plate.

8. A metal gasket according to claim 7, wherein said second metal plate has a ring shape, and the third metal plate is situated so that the second full bead projects toward a base portion of the first metal plate.

9. A metal gasket according to claim 8, further comprising an additional metal plate disposed on the third metal plate having an additional full bead projecting in a direction opposite to the second full bead.
